(19) United States
(12) Patent Application Publication
(10) Pub. No.: US 2025/0320828 A1
(43) Pub. Date: Oct. 16, 2025

(54) ENGINE

(71) Applicant: TOYOTA JIDOSHA KABUSHIKI KAISHA, Toyota-shi (JP)

(72) Inventor: Toru SAKUMA, Toyota-shi (JP)

(21) Appl. No.: 19/055,523

(22) Filed: Feb. 18, 2025

(30) Foreign Application Priority Data
Apr. 11, 2024 (JP) 2024-063982

(51) Int. Cl. F01M 13/00; F01M 13/02

(52) U.S. Cl. CPC F01M 13/0011; F01M 13/022

(57) ABSTRACT

An engine is provided. An air introduction passage connects an intake passage to a crankcase. The crankcase is ventilated by introducing air from the intake passage into the crankcase. A unidirectional valve restricts a flow of gas from the crankcase toward the intake passage through the air introduction passage. A valve housing is fixed to an outer wall of the crankcase. The unidirectional valve is attached to the crankcase, with the unidirectional valve sandwiched between the crankcase and the valve housing.

### CROSS-REFERENCE TO RELATED APPLICATIONS

This application is based upon and claims the benefit of priority from prior Japanese Patent Application No. 2024-063982, filed on Apr. 11, 2024, the entire contents of which are incorporated herein by reference.

### BACKGROUND

### 1. Field

The present disclosure relates to an engine. The engine includes a crankcase ventilation system.

### 2. Description of Related Art

### BACKGROUND

Japanese Laid-Open Patent Publication No. 2011-185181 discloses an engine including a known ventilation system. In the ventilation system, air is introduced from the intake passage into the crankcase. Thus, the blow-by gas in the crankcase is ventilated.

The ventilation system includes a unidirectional valve. The unidirectional valve prevents backflow of gas from the crankcase toward the intake passage.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides an engine. The engine includes an air introduction passage that connects an intake passage to a crankcase so that the crankcase is ventilated by introducing air from the intake passage into the crankcase. A unidirectional valve restricts the flow of gas from the crankcase toward the intake passage through the air introduction passage. A valve housing is fixed to an outer wall of the crankcase. The unidirectional valve is attached to the crankcase, with the unidirectional valve sandwiched between the crankcase and the valve housing.

The engine limits the occurrence of emulsion.

The unidirectional valve of the ventilation system is exposed to blow-by gas. The blow-by gas contains moisture and oil. When the temperature of the unidirectional valve or the temperature around the unidirectional valve is relatively low, the moisture in the blow-by gas is condensed. If oil is mixed in the condensed water, emulsion may occur. The above-described configuration reduces such a risk.

Other features and aspects will be apparent from the following detailed description, the drawings, and the claims.

### BRIEF DESCRIPTION OF THE DRAWINGS

FIG. 1 is a diagram schematically showing a configuration of an engine according to an embodiment.

FIG. 2 is a side view of an oil pan and the vicinity thereof in the engine of FIG. 1.

FIG. 3 is a cross-sectional view showing a cross-sectional structure of the valve housing of the engine and its vicinity taken along line 3-3 of FIG. 2.

FIG. 4 is a cross-sectional view showing a cross-sectional structure of the valve housing of the engine and the vicinity thereof taken along line 4-4 of FIG. 2.

FIG. 5 is a cross-sectional view of the unidirectional valve and the vicinity thereof in another embodiment of the engine.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

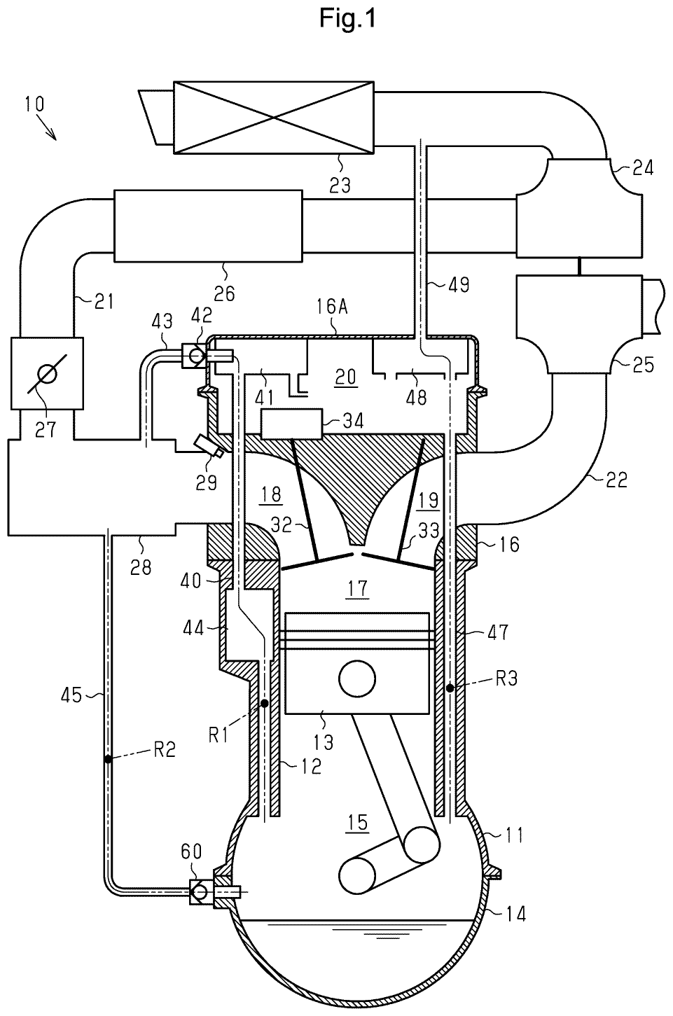

Hereinafter, an embodiment of an engine will be described in detail with reference to FIGS. 1 to 4.

### Configuration of Engine 10

The configuration of an engine 10 will now be described with reference to FIG. 1. The engine 10 shown in FIG. 1 is a hydrogen engine that generates power by burning hydrogen. The blow-by gas in the hydrogen engine may contain combustible hydrogen. Therefore, the ventilation performance of the blow-by gas of the hydrogen engine is required to be higher than the ventilation performance of the gasoline engine or the diesel engine.

The engine 10 includes a cylinder block 11. Cylinders 12 are formed inside the cylinder block 11. FIG. 1 shows only one of the cylinders 12. Each cylinder 12 reciprocally accommodates a piston 13. The portion of the cylinder 12 on the upper side of the piston 13 includes a combustion chamber 17 that burns hydrogen. An oil pan 14 that stores oil is attached to the lower part of the cylinder block 11. The portion of the cylinder block 11 on the lower side of the cylinder 12 includes a crankcase 15. A cylinder head 16 is mounted on the upper part of the cylinder block 11. In the cylinder head 16, an intake port 18 and an exhaust port 19 are individually formed for each cylinder 12. A head cover 16A is mounted on the upper side of the cylinder head 16. A valve operating chamber 20 that accommodates a valvetrain is formed inside the upper part of the cylinder head 16, covered by the head cover 16A.

The engine 10 includes an intake passage 21, through which air is drawn into the combustion chamber 17, and an exhaust passage 22, through which exhaust gas is discharged from the combustion chamber 17. The intake passage 21 includes an air cleaner 23 that filters dust or the like from the air. The portion of the intake passage 21 downstream of the air cleaner 23 includes a compressor 24. The exhaust passage 22 includes a turbine 25. The compressor 24 and the turbine 25 form a turbocharger. The portion of the intake passage 21 downstream of the compressor 24 includes an intercooler 26. The intercooler 26 is a heat exchanger used to cool the air that has been heated due to compression by the compressor 24. The portion of the intake passage 21 downstream of the intercooler 26 includes an throttle valve 27. The throttle valve 27 regulates the flow rate of air delivered through the intake passage 21 to the combustion chamber 17. The intake passage 21 branches for each cylinder 12 in an intake manifold 28 that is located downstream of the throttle valve 27. The intake manifold 28 is connected to the combustion chamber 17 through the intake port 18.

The engine 10 includes an injector 29 that injects hydrogen into air used for combustion in the combustion chamber 17. In FIG. 1, the injector 29 is disposed to inject hydrogen into the intake port 18. Instead, the injector 29 may be disposed to inject hydrogen into the combustion chamber 17. The engine 10 includes an intake valve 32 that opens and closes the intake port 18 to the combustion chamber 17, and an exhaust valve 33 that opens and closes the exhaust port 19 to the combustion chamber 17.

### Ventilation System

The engine 10 includes a ventilation system for the crankcase 15. The ventilation system includes three passages, each connecting the intake passage 21 to the crankcase 15. That is, each of the first passage R1, the second passage R2, and the third passage R3 connects the intake passage 21 to the crankcase 15.

The first passage R1 connects the portion of the intake passage 21 downstream of the throttle valve 27 to the crankcase 15. The first passage R1 includes a blow-by gas passage 40, a first separator 41, a PCV valve 42, a first PCV hose 43, and a second separator 44. The first separator 41 and the second separator 44 separate oil mist from the blow-by gas flowing through the first passage R1. The first separator 41 is attached to the inner side of the head cover 16A. The blow-by gas passage 40 connects the crankcase 15 to the first separator 41 by passing through the cylinder block 11 and the cylinder head 16. The second separator 44 is provided in the blow-by gas passage 40 in the cylinder block 11. The first PCV hose 43 connects the first separator 41 to the intake manifold 28. The PCV valve 42 permits the flow of gas from the crankcase 15 toward the intake passage 21 through the first passage R1. The PCV valve 42 restricts the flow of gas from the intake passage 21 into the crankcase 15 through the first passage R1. The PCV valve 42 is provided at a portion of the first PCV hose 43 connected to the first separator 41.

The second passage R2 connects the portion of the intake passage 21 downstream of the compressor 24 to the crankcase 15. That is, the second passage R2 is an air introduction passage that introduces air from the intake passage 21 to the crankcase 15 by connecting the intake passage 21 to the crankcase 15. The second passage R2 of FIG. 1 is configured to connect the intake manifolds 28 to the crankcase 15. The second passage R2 includes a second PCV hose 45 and a unidirectional valve 60. The second PCV hose 45 connects the crankcase 15 to the intake manifold 28. The unidirectional valve 60 permits the flow of air from the intake passage 21 toward the crankcase 15 through the second passage R2. The unidirectional valve 60 restricts the flow of gas from the crankcase 15 toward the intake passage 21 through the second passage R2. In the engine 10 of the present embodiment, the unidirectional valve 60 is attached to the crankcase 15. Details of the structure for attaching the unidirectional valve 60 to the crankcase 15 will be described later.

The third passage R3 connects the portion of the intake passage 21 upstream of the compressor 24 to the crankcase 15. The third passage R3 includes an oil return passage 47, the valve operating chamber 20, a third separator 48, and a third PCV hose 49. The oil return passage 47 connects the valve operating chamber 20 to the crankcase 15 by passing through the cylinder block 11 and the cylinder head 16. The oil return passage 47 serves as a passage for returning oil from the valve operating chamber 20 to the oil pan 14. The oil return passage 47 also serves as a passage for circulating gas between the valve operating chamber 20 and the crankcase 15. The third separator 48 separates oil mist from the blow-by gas flowing through the third passage R3. The third separator 48 is provided inward of the head cover 16A. The third PCV hose 49 connects a portion of the intake passage 21 downstream of the air cleaner 23 and upstream of the compressor 24 to the third separator 48.

During the naturally aspirated operation of the engine 10, the portion of the intake passage 21 downstream of the throttle valve 27 has a negative pressure. Due to this negative pressure, the blow-by gas in the crankcase 15 is drawn into the intake passage 21 through the first passage R1. In addition, air is introduced into the crankcase 15 through the third passage R3. During the bosting operation of the engine 10, the portion of the intake passage 21 downstream of the compressor 24 has a positive pressure. The air having a positive pressure is introduced into the crankcase 15 from the intake passage 21 through the second passage R2. The blow-by gas in the crankcase 15 is pushed out by the introduced air. The blow-by gas that has been pushed out is discharged to the intake passage 21 through the third passage R3.

### Attachment Structure for Unidirectional Valve 60

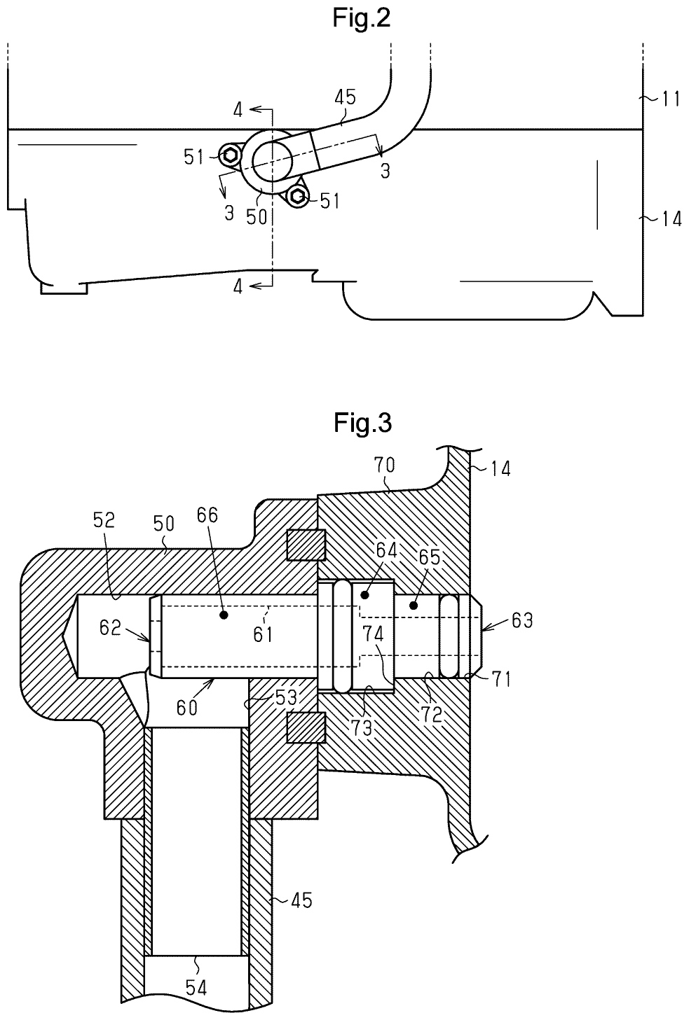

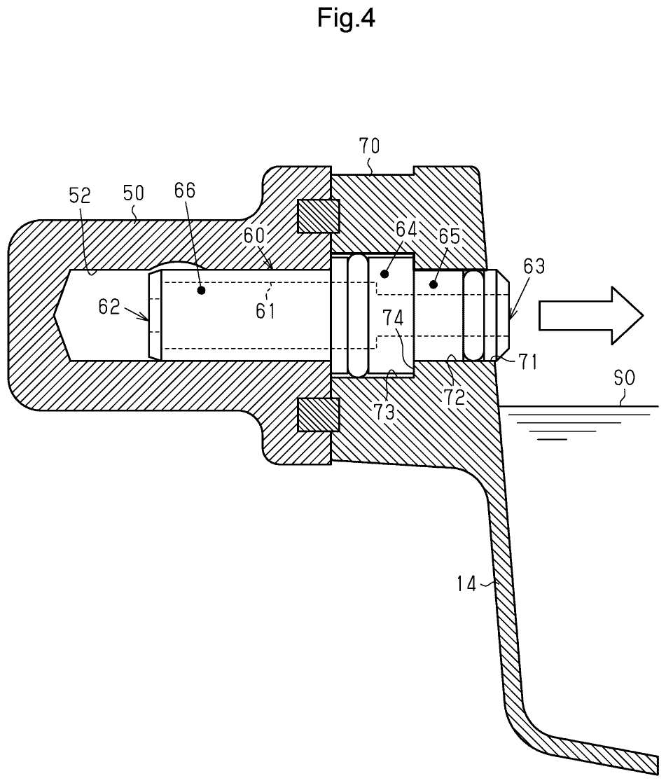

In the engine 10 of the present embodiment, the unidirectional valve 60 is directly attached to the crankcase 15. The unidirectional valve 60 restricts the flow direction of gas in the second passage R2. The attachment structure for the unidirectional valve 60 to the crankcase 15 will now be described with reference to FIGS. 2 to 4. FIG. 2 is a side view of the oil pan 14 of the engine 10 and the vicinity of the oil pan 14. FIG. 3 shows a cross-sectional structure of the valve housing 50 and the vicinity of the valve housing 50 taken along line 3-3 of FIG. 2. FIG. 4 shows a cross-sectional structure of the valve housing 50 and the vicinity of the valve housing 50 taken along line 4-4 in FIG. 2. The engine 10 includes the valve housing 50 for attaching the unidirectional valve 60 to the crankcase 15.

As shown in FIG. 2, the valve housing 50 is fixed to the outer wall of the side portion of the oil pan 14 by a plurality of bolts 51. In FIG. 2, the valve housing 50 is fixed by two bolts 51. One bolt 51 or three or more bolts 51 may fix the valve housing 50 to the oil pan 14.

As shown in FIGS. 3 and 4, the unidirectional valve 60 is generally in the form of a circular tube having a valve flange 64. That is, the unidirectional valve 60 has a through-hole 61 extending from a first end to a second end of the circular tube. A first end of the through-hole 61 serves as an inlet 62 for air flowing from the intake passage 21. A second end of the through-hole 61 serves as an outlet 63 for air flowing to the inside of the crankcase 15. The outer diameter of the valve flange 64 is larger than the outer diameters of other portions of the unidirectional valve 60. In the following description, the portion of the unidirectional valve 60 that extends from the valve flange 64 toward the outlet 63 is referred to as a valve front portion 65. The portion of the unidirectional valve 60 that extends from the valve flange 64 toward the inlet 62 is referred to as a valve rear portion 66. The valve front portion 65 may also be referred to as a front end. The valve rear portion 66 may also be referred to as a rear end.

Although not shown in FIGS. 3 and 4, a check mechanism is incorporated in the unidirectional valve 60. The check mechanism restricts the flow of gas in a direction from the outlet 63 toward the inlet 62 through the through-hole 61. The check mechanism may be, for example, a well-known mechanism including a valve member, a spring that biases the valve member, and the like.

As shown in FIGS. 3 and 4, a boss 70 is provided at the portion of the crankcase 15 where the unidirectional valve 60 is mounted. The boss 70 has an insertion hole 71 that connects the interior to the exterior of the crankcase 15. The insertion hole 71 includes a small-diameter portion 72 located inside the crankcase 15 and a large-diameter portion 73 located outside the crankcase 15. The valve front portion 65 is inserted into the small-diameter portion 72. The large-diameter portion 73 accommodates the valve flange 64 of the unidirectional valve 60. The insertion hole 71 includes a step 74 between the small-diameter portion 72 and the large-diameter portion 73. That is, the step 74 is provided in the insertion hole 71 of the crankcase 15. The step 74 has a surface orthogonal to the extending direction of the insertion hole 71. Bolt holes are formed in portions of the boss 70 that are not shown in the cross-sectional views of FIGS. 3 and 4. The bolts 51, which are used to fix the valve housing 50, are inserted into the bolt holes, respectively.

The valve housing 50 has an insertion hole 52 into which the valve rear portion 66 is inserted. The valve housing 50 has a connection hole 53. The insertion hole 52 passes through the outer circumferential surface of the valve housing 50 through the connection hole 53. The second PCV hose 45 is connected to the connection hole 53 by a joint 54. The unidirectional valve 60 is attached to the crankcase 15, with the valve flange 64 sandwiched between the shoulder 74 and the valve housing 50.

In the following description, the state in which a vehicle including the engine 10 is stationary on a horizontal plane will be referred to as a reference state. In FIG. 4, “SO” indicates a reference oil level in the crankcase 15. The reference oil level is a liquid level of the engine oil in the crankcase 15 in a case in which the upper limit amount of the engine oil in a proper range has been injected into the engine 10 in the reference state. The unidirectional valve 60 is attached to the crankcase 15 such that the outlet 63 is positioned vertically above the reference oil level in the reference state. The unidirectional valve 60 is attached to the crankcase 15 such that the discharge direction of air from the outlet 63 is the horizontal direction in the reference state.

### Operation of Embodiment

The engine 10 of the present embodiment is a hydrogen engine. That is, the engine 10 generates power by burning hydrogen. The unidirectional valve 60 is attached to the portion of the engine 10 that is exposed to blow-by gas in the crankcase 15.

The blow-by gas contains oil and moisture. When the temperature of the unidirectional valve 60 or the temperature around the unidirectional valve 60 is relatively low, the moisture in the blow-by gas may be condensed and liquefied. When the condensed water is mixed with the oil, emulsion may occur. In a low-temperature environment, when the engine 10 is stopped in a state in which the condensed water remains in the unidirectional valve 60, the remaining water may freeze while the engine 10 is stationary. In this case, the unidirectional valve 60 may not operate properly until the ice melts during the next operation of the engine 10.

The unidirectional valve 60 of the engine 10 of the present embodiment is directly attached to the crankcase 15. The periphery of the unidirectional valve 60 is covered by the valve housing 50. Even if the temperature of the unidirectional valve 60 mounted in this manner is relatively low before the start of the engine 10, the unidirectional valve 60 is quickly warmed by the heat received from the crankcase 15 after the start of the engine 10. This limits the occurrence of emulsion or freezing in the unidirectional valve 60.

### Advantages of Embodiment

The engine 10 of the present embodiment provides the following advantages.

(1) The engine 10 includes the second passage R2 and the unidirectional valve 60. The second passage R2 is the air introduction passage, which introduces air into the crankcase 15 by connecting the intake passage 21 to the crankcase 15. The unidirectional valve 60 restricts the flow of gas from the crankcase 15 toward the intake passage 21 through the second passage R2. In the engine 10, air is introduced from the intake passage 21 into the crankcase 15 through the second passage R2 so that the crankcase 15 is ventilated. The engine 10 includes the valve housing 50, which is fixed to the outer wall of the crankcase 15. The unidirectional valve 60 is directly attached to the crankcase 15, with the unidirectional valve 60 sandwiched between the crankcase 15 and the valve housing 50. The unidirectional valve 60 directly attached to the crankcase 15 is likely to be warmed by heat received from the crankcase 15. This limits the occurrence of emulsion or freezing in the unidirectional valve 60 that would result from relatively low temperatures.

(2) As a comparative example, if the air that has been discharged from the unidirectional valve 60 is directly blown to the engine oil in the oil pan 14, the oil surface of the engine oil becomes wavy. This may increase the aeration rate of the engine oil. Also, blowing air onto the engine oil may increase the amount of engine oil that is atomized. When the engine oil atomized in the crankcase 15 returns to the intake air together with the blow-by gas, the engine oil burns in the combustion chamber 17. This may increase the amount of engine oil consumed.

In the engine 10 of the present embodiment, the unidirectional valve 60 is provided as follows. When the vehicle on which the engine 10 is mounted is stationary on a horizontal plane, the discharge direction of the air from the outlet 63 of the unidirectional valve 60 toward the inside of the crankcase 15 is the horizontal direction. The unidirectional valve 60 is attached to the crankcase 15 such that the outlet 63 is positioned vertically above the reference oil level in the reference state. Therefore, the air discharged from the outlet 63 of the unidirectional valve 60 is unlikely to be directly blown to the engine oil stored in the crankcase 15. Accordingly, the present embodiment limits an increase in the aeration rate of the engine oil. Further, the loss of engine oil from the crankcase 15 is limited. Accordingly, an increase in the amount of engine oil consumed due to the loss of the engine oil is limited.

(3) The engine 10 of the present embodiment is a hydrogen engine. The hydrogen engine generates power by burning hydrogen. When hydrogen burns, water is produced. Therefore, the amount of moisture contained in the blow-by gas of a hydrogen engine tends to be larger than that of a gasoline engine, a diesel engine, or the like. When the amount of moisture in the blow-by gas increases, the amount of condensed water generated in the unidirectional valve 60 at a relatively low temperature may also increase. In the above-described attachment structure for the unidirectional valve 60, the unidirectional valve 60 is readily warmed by the heat received from the crankcase 15. Thus, the above-described attachment structure for the unidirectional valve 60 is particularly suitable for application to a hydrogen engine.

### Modifications

The present embodiment may be modified as follows. The present embodiment and the following modifications can be combined as long as the combined modifications remain technically consistent with each other.

The valve housing 50 does not have to contain the entire unidirectional valve 60. For example, the rear end of the unidirectional valve 60 may protrude from the valve housing 50. The component corresponding to the connection hole 53 may be omitted from the valve housing 50. For example, the valve housing 50 may have a configuration in which the valve flange 64 of the unidirectional valve 60 is sandwiched between the valve housing 50 and the outer wall of the crankcase 15.

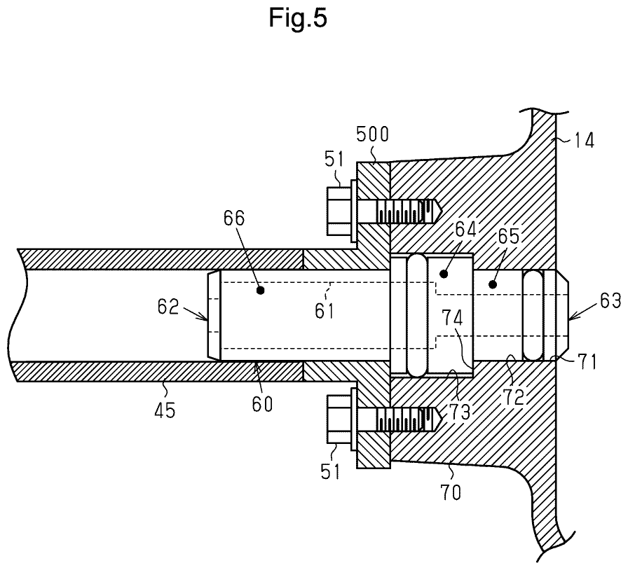

FIG. 5 shows the valve housing 500 of a modification. The unidirectional valve 60 is attached to the crankcase 15, with the valve flange 64 sandwiched between the valve housing 500 and the crankcase 15. The rear end of the valve rear portion 66 protrudes outward from the valve housing 500. The second PCV hose 45 is connected to the rear end of the valve rear portion 66 protruding from the valve housing 500. As long as the valve housing 50 is capable of fixing the unidirectional valve 60 by sandwiching the unidirectional valve 60 between the valve housing 50 and the outer wall of the crankcase 15, the shape and the like of the valve housing 50 may be changed.

The unidirectional valve 60 of the above-described embodiment is attached to the crankcase 15, with the discharge direction of air from the outlet 63 corresponding to the horizontal direction in the reference state. The unidirectional valve 60 may be attached to the crankcase 15 in a different orientation.

As long as the ventilation system for the engine 10 includes the second passage R2 provided with the unidirectional valve 60, the ventilation system may be changed. For example, when the ventilation of the crankcase 15 does not have to be performed during the naturally aspirated operation of the engine 10, the first passage R1 may be omitted.

The engine 10 is not limited to a hydrogen engine.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An engine, comprising:
an air introduction passage that connects an intake passage to a crankcase so that the crankcase is ventilated by introducing air from the intake passage into the crankcase;
a unidirectional valve that restricts a flow of gas from the crankcase toward the intake passage through the air introduction passage; and
a valve housing fixed to an outer wall of the crankcase, wherein
the unidirectional valve is attached to the crankcase in a state in which the unidirectional valve is sandwiched between the crankcase and the valve housing.

2. The engine according to claim 1, wherein
the engine is mounted on a vehicle, and
the unidirectional valve is provided such that a discharge direction of air discharged from the unidirectional valve into the crankcase corresponds to a horizontal direction when the vehicle is stationary on a horizontal plane.

3. The engine according to claim 1, wherein
the engine is a hydrogen engine that generates power by burning hydrogen.
